(19) United States
(12) Patent Application Publication
(10) Pub. No.: US 2006/0269802 A1
(43) Pub. Date: Nov. 30, 2006

(54) Electric energy storage device

(76) Inventors: Takahiro Yamaki, Hitachinaka (JP); Juichi Arai, Shirosato (JP); Yoshiaki Kumashiro, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/438,354

(22) Filed: May 23, 2006

(30) Foreign Application Priority Data
May 24, 2005 (JP) 2005-150315

(51) Int. Cl. H01M 16/00; H01M 4/58

(52) U.S. Cl. 429/9; 429/231.8

(57) ABSTRACT

A long-life electric energy storage device with superior high-input/output load resistance includes a cathode including a region having a faradic reaction mechanism and a region having a non-faradic reaction mechanism, and an anode including a region having a faradic reaction mechanism. When carbon material contained in the anode is represented by a diffraction line according to X-ray diffraction method, mainly the (001) plane is substantially detected.

### BACKGROUND OF THE INVENTION

1. Field of the Invention

The present invention relates to an electric energy storage device, such as lithium ion batteries.

2. Background Art

In recent years, there is a growing need for a long-life power supply for powering electric vehicles or hybrid electric vehicles or the like that has superior high-input/output characteristics and that has superior high-input/output load resistance.

At the same time, there is a need for a high-capacity power supply capable of storing more energy.

So far, these needs have been addressed by improving the performance of secondary batteries having a faradic reaction mechanism, such as lithium ion battery and nickel metal hydride battery, or by using a secondary battery in combination with an electric double layer capacitor, which has a non-faradic reaction mechanism and good instantaneous input/output characteristics.

Patent Document 1 discloses that activated carbon is added to the cathode mix in a lithium ion battery so as to increase the electric double layer capacitance.

Patent Document 1: JP Patent Publication (Kokai) No. 2002-260634 A

### SUMMARY OF THE INVENTION

It is an object of the invention to provide a long-life electric energy storage device that has superior high-input/output load resistance.

It is another object of the invention to provide a long-life, high-output, and high-capacity electric energy storage device.

In one embodiment of the invention, an electric energy storage device includes a cathode including a region having a faradic reaction mechanism and a region having a non-faradic reaction mechanism, and an anode including a region having a faradic reaction mechanism. In this device, when carbon material contained in the anode is represented by a diffraction line according to X-ray diffraction method, the (001(L)) plane is substantially mainly detected.

In accordance with the invention, a long-life electric energy storage device that has superior high-input/output load resistance is provided. More desirably, a long-life, high-output, and high-capacity electric energy storage device is provided.

An electric energy storage device according to one embodiment of the invention includes a cathode including a region having a faradic reaction mechanism and a region having a non-faradic reaction mechanism, and an anode including a region having a faradic reaction mechanism.

When carbon material contained in the anode is represented by a diffraction line according to X-ray diffraction method, the (001(L)) plane is substantially mainly detected.

Namely, in such electric energy storage device, it is important to consider both the cathode and anode and to strike an appropriate balance between them.

Preferably, the region having the faradic reaction mechanism and the region having the non-faradic reaction mechanism are formed in layers. The region having the non-faradic reaction mechanism may be distributed in the region having the faradic reaction mechanism.

Preferably, when carbon material contained in the anode is represented by a diffraction line according to X-ray diffraction method, the peak intensity ratio of the (002) plane to the (hk0) plane ((hk0)/(002)) is 0.01 or lower.

Preferably, the faradic reaction mechanism is a lithium ion intercalation/desorption reaction and the non-faradic reaction mechanism is an anion absorption/desorption reaction.

The carbon material contained in the anode is an anode active material that causes a lithium ion intercalation/desorption reaction and is such that:
(1) The interlayer spacing of the (002) plane (d value) according to X-ray diffraction method is 0.343 nm to 0.390 nm.
(2) The crystallite thickness (Lc) in the C-axis direction of the (002) plane according to X-ray diffraction method is 1.6 nm to 100 nm.

Preferably, the anode active material is such that:
(1) The true density according to helium absorption method is 1.6 g/cm³ to 2.1 g/cm³.
(2) The true density according to butanol method is 1.5 g/cm³ to 2.0 g/cm³.
(3) The interlayer spacing of the (002) plane (d value) according to X-ray diffraction method is 0.343 nm to 0.365 nm.
(4) The crystallite thickness (Lc) of the (002) plane in the C axis direction according to X-ray diffraction method is 3.0 nm to 100 nm.

The carbon material has a structure consisting of a set of unit structures (crystallites) each consisting of a stack of hexagonal planes comprised of carbon atoms. The interlayer spacing of the carbon hexagonal planes is measured in terms of an interlayer spacing of the (002) plane (d value) according to X-ray diffraction method. The number of layers in the stack is measured in terms of the crystallite thickness (Lc) in the C axis direction according to X-ray diffraction method.

When lithium ion as the anode active material is desorbed from or intercalated between the layers of the carbon material, the interlayer spacing varies, such as from 0.336 nm to 0.370 nm in the case of highly crystalline graphite, for example.

The inventors found that an electric energy storage device having superior high-input/output load resistance can be obtained by using a carbon material having d value and Lc value within certain ranges in the anode active material.

Specifically, when the d value is lower than 0.343, the variation of the interlayer spacing during the desorption or intercalation of lithium ion becomes large such that, as a result of the repetition of high input and output, the crystallites collapse and performance significantly deteriorates. On the other hand, if the d value exceeds 0.390 nm, the interlayer spacing of the hexagonal planes increases and the structure of the crystallites is disturbed, thereby hindering the desorption and intercalation of lithium ion and resulting in a failure to achieve sufficient device performance.

If the Lc value is below 1.6 nm, the number of the layers for the desorption and intercalation of the lithium ion would be too small and sufficient device performance would not be obtained. If the Lc value exceeds 100 nm, the expansion or contraction of the crystallites during the desorption and intercalation of lithium ion would increase, whereby the crystallites would collapse due to the repetition of high input and output and performance would significantly deteriorate.

The Lc value is more preferably 16.0 nm or smaller.

Preferably, when the d and Lc values of the carbon material for the anode active material are measured, a powder X-ray diffraction method of reflection diffraction type is used.

A carbon material powder in which preferably a certain quantity of Si powder or the like is mixed as an internal reference is irradiated with a CuKα ray using Cu as a target and with a tube voltage of 50 kV and a tube current of 150 mA. A diffraction line is measured with a goniometer, thereby obtaining a powder X-ray diffraction spectrum.

Based on a diffraction peak of the (002) plane in the range of 2θ from 20° to 30°, the interlayer spacing of the (002) plane (d value) is determined in accordance with the Bragg equation, and the crystallite thickness in the C axis direction (Lc) is determined in accordance with the Scherrer equation.

In order to measure the diffraction line of the anode, the anode is similarly irradiated with X-ray as in the case of the powder of carbon material, 2θ is measured in the range of 20° to 60°, and the diffraction line of the (002) plane in the range of 20° to 30° and the diffraction line in the (004) plane in the range of 40° to 45° are detected. It is then determined if there are other peaks. Normally, these other diffraction lines are not substantially observable.

The measurement of 2θ in the range of 20° to 60° is based on an empirical rule.

A plurality of the electric energy storage devices may be electrically connected to constitute an electric energy storage module. The electric energy storage device may be used at least as part of a power source in transport equipment. The electric energy storage device may be used at least as part of a power source in a hybrid electric vehicle or the like having an internal combustion engine or a fuel cell that is used as another part of the power source, in which the internal combustion engine or fuel cells is used as an energy source for charging the electric energy storage device.

The region having the non-faradic reaction mechanism preferably consists of activated carbon.

In another embodiment of the electric energy storage device of the invention, a cathode may be used that includes a first region for charging or discharging lithium ion, and a second region for charging or discharging lithium ion at a greater rate than the charging or discharging of the lithium ion in the first region.

### BRIEF DESCRIPTION OF THE DRAWINGS

FIG. 1 schematically shows a cross section of an electric energy storage device according to an embodiment of the invention.

FIG. 2 shows an X-ray diffraction line of the anode of device A according to the present embodiment.

FIG. 3 shows the relationship between the rate of increase in resistance and the number of cycles in the electric energy storage device according to the present embodiment.

FIG. 4 shows the relationship between the rate of increase in resistance and the number of cycles in the electric energy storage device (Example 2) according to the present embodiment.

### DESCRIPTION OF THE PREFERRED EMBODIMENTS

In the following, an embodiment of the electric energy storage device of the invention will be described.

The cathode includes a region having a faradic lithium ion desorption/intercalation reaction mechanism and a region having a non-faradic lithium ion absorption/desorption reaction mechanism.

In a specific example, a mix layer containing a cathode active material that causes a faradic lithium ion desorption/intercalation reaction is provided on a collector (foil) of metallic aluminum as a faradic region.

On such mix layer, a layer that causes a non-faradic anion absorption/desorption reaction, such as a layer having activated carbon, is provided. The non-faradic reaction mechanism refers to a mechanism that causes an ion absorption/desorption reaction.

As compared with the faradic reaction, the non-faradic reaction has a higher reaction rate. By providing such region having a non-faradic reaction mechanism with the higher reaction rate, an electric energy storage device that has superior high-input/output resistance can be provided.

A similar operation can be expected by mixing a certain quantity of non-faradic reaction material, such as activated carbon, in the region having a faradic reaction mechanism, such as the lithium ion desorption/intercalation reaction mechanism.

A similar operation can be expected in an embodiment involving a composite of a cathode active material and a non-faradic reaction material.

The mode or method for manufacturing a composite for the cathode active material are not particularly limited. For example, a method may be employed whereby a resin is mixed in a cathode active material as a carbon source and subjected to heat treatment in a certain quantity of oxidative atmosphere, thereby transforming the resin into activated carbon.

In an embodiment of the cathode of the electric energy storage device, a cathode active material having a faradic reaction mechanism and a material having a non-faradic reaction mechanism may be present substantially homogeneously.

Specifically, a mix layer consisting of a mixture of a cathode active material and a material having a non-faradic reaction mechanism, such as activated carbon is provided on a collector (foil) of metallic aluminum.

By thus mixing a material having a non-faradic reaction with a higher reaction rate in the cathode mix layer, a high-output electric energy storage device that has superior high-input/output load resistance can be provided.

However, in such embodiment of the cathode, ions that have become absorbed in or desorbed from the activated carbon diffuse and move in the cathode mix layer, thereby possibly reducing the diffusion rate of the ions. As a result, as compared with the embodiment in which the region having a non-faradic reaction mechanism is provided, the high-input/output load resistance and output could become slightly inferior.

With regard to the diffraction line of the carbon material as the anode active material according to X-ray diffraction method, substantially the (001) plane alone is detected.

This is due to the fact that the size of the crystallites of the carbon material in terms of the number of the layers in the stack of the hexagonal planes is small at several dozens of layers, which makes it substantially impossible to obtain a diffraction line due to a diffraction plane (such as (hk1)(hk0), for example) in the direction in which the hexagonal planes are stacked using X-ray diffraction method.

The density of the anode mix in the anode is preferably 1.1 g/cm³ to 1.7 g/cm³. By increasing the density of the anode mix, capacity per unit volume can be increased and therefore a higher capacity device can be obtained.

As the d value, which indicates the interlayer spacing of the hexagonal planes of the carbon material, increases, the true density decreases. As the Lc value, which indicates the size of the crystallites in the carbon material, decreases, the volume of the gap that exists between the crystallites increases, so that the true density drops.

Thus, it is preferable that the carbon material has a d value of 0.343 to 0.365 nm, a Lc value is 3.0 nm to 100 nm, a true density according to helium absorption method of 1.6 g/cm³ to 2.1 g/cm³, and a true density according to butanol method of 1.5 g/cm³ to 2.0 g/cm³.

A carbon material having such true density is preferably used in the anode also from the viewpoint of achieving an anode mix density of 1.1 g/cm³ to 1.7 g/cm³.

Obviously, there is an upper limit to the anode mix density with respect to the true density of the carbon material.

Thus, in a carbon material such that the upper limit of its true density, namely, the true density according to helium absorption method is 2.1 g/cm³ and the true density according to butanol method is 2.0 g/cm³, the upper limit of the anode mix density is 1.7 g/cm³.

Manufacture of a carbon material having an anode mix density exceeding such upper limit value is difficult and the characteristics of such carbon material would deteriorate due to the collapse of the powder particle of the carbon material, for example.

The measurement of the true density according to helium absorption method can be made by measuring the difference in volume of a sample container with a known volume between when it contains a carbon material with a known weight and when it is not, and then dividing the weight with the thus measured volume difference.

The measurement of true density according to butanol method can be made by determining the volume using a pycnometer and then dividing the volume with weight.

By thus measuring the true density with these two methods, it becomes possible to define the surface shape and internal shape of carbon material, thus making it possible to specify a desirable carbon material as an anode active material used in an electric energy storage device.

Preferably, as a desirable physical property of the carbon material for the anode, upon irradiation with an argon laser with a wavelength of 514.5 nm and an output of 50 W, the ratio of a peak intensity (I_{D}) in a range of 1300 to 1400 cm⁻¹ to a peak intensity (I_{G}) in a range of 1580 to 1620 cm⁻¹, or an R value (I_{D}/I_{G}), that is measured in terms of a Raman optical spectrum, is 0.6 to 1.5.

Preferably, as a desirable physical property of the carbon material for the anode, the average particle diameter according to optical diffraction method is 2 μm to 30 μm.

Preferably, as a desirable physical property of the carbon material for the anode, the specific surface area according to helium absorption method is 2 m²/g to 10 m²/g.

Such carbon material has superior high-input/output characteristics.

Hereafter, a concrete example of a means for realizing an electric energy storage device will be described.

A cathode is prepared.

Initially, a cathode active material having a faradic reaction and a material having a non-faradic reaction are selected.

Examples of the cathode active material include a layered oxide having a general formula of LiMO₂ (where primary constituent elements of M are one or more of Co, Mn, and Ni), a spinel-based cathode material, such as LiMn₂O₄, and a phosphate compound expressed by a general formula LiMPO₄ (where M is Mn, Fe, or the like).

Examples of the material having a non-faradic reaction include porous carbon material, such as activated carbon, and a porous inorganic compound, with a specific surface area of preferably 500 m²/g or more.

Further, a compound material of a cathode active material and a material having the non-faradic reaction, such as activated carbon, may also be used.

Next, a region having a faradic reaction mechanism is formed.

Appropriate amounts (1 to 15 wt. % of the weight of the cathode mix after drying) of conductant agents, such as graphite, carbon, carbon black, carbon fiber, and the like are added to the cathode active material, to which a powder of porous material is further added as needed. A binder (2 to 10 wt. % of the weight of the cathode mix after drying) dissolved or dispersed in an appropriate solvent is further added and kneaded well, thereby preparing a cathode mix slurry.

The binder may be a fluorine resin, such as polyvinylidene-fluoride (PVDF). The solvent for dissolving such binder may be N-methyl pyrrolidone (NMP), for example.

The cathode mix slurry is applied to the metal foil of aluminum or the like and then dried.

Further, in a similar step, the cathode mix slurry is applied to both sides of the metal foil and dried, which is then subjected to compression molding as needed,

In order to prepare the region having the non-faradic reaction mechanism, after the compression molding, a binder dissolved or dispersed in an appropriate solvent is added to a porous material and kneaded well. The resultant slurry is applied in the same way as the prepared cathode mix slurry and then dried.

After compression molding, the metal foil is cut to a desired size, thereby preparing a cathode.

In the above example, the cathode of a so-called layered structure is prepared by forming a material having a non-faradic reaction superposed on a region having a faradic reaction mechanism. This is merely an example and the invention is not limited thereto. For example, regions having a faradic reaction mechanism and material having a non-faradic reaction may be formed in stripes in a direction substantially perpendicular to the direction in which the anode is disposed.

An anode is formed.

A proper example of an anode active material is a carbon material that has an interlayer spacing (d value) of the (002) plane according to X-ray diffraction method of 0.343 nm to 0.390 nm, the crystallite thickness (Lc) in the C axis direction of the (002) plane of 1.6 nm to 100 nm, the true density according to helium absorption method of 1.6 g/cm³ to 2.1 g/cm³, preferably the true density according to butanol method of 1.5 g/cm³ to 2.0 g/cm³, and the d value according to X-ray diffraction method of 0.343 nm to 0.365 nm, and the Lc value of 3.0 nm to 100 nm.

Preferably, conductant agent (1 to 10 wt. % of the weight of the anode mix after drying) such as carbon black, acetylene black, and carbon fiber is added to the anode active material, to which a binder such as PVDF dissolved in NMP is added and kneaded well, thereby preparing an anode mix slurry.

The anode mix slurry is applied to a metal foil of copper or the like and then dried.

In a similar step, the anode mix slurry is applied to both sides of the metal foil, dried, and, as needed, subjected to compression molding.

After the compression molding, the metal foil is cut to a desired size, thereby preparing an anode.

Preferably, the density of the mix after compression molding is 1.1 g/cm³ to 1.7 g/cm³.

When a cylindrical electric energy storage device is to be prepared, the following process is employed.

The cathode and anode obtained above are used. As a mechanism for electrically insulating the cathode and the anode, a separator comprised of a porous insulating film with a thickness of 15 to 50 μm is placed between the cathode and the anode. The separator is then wound in a cylinder so as to prepare a stack of electrodes. The thus prepared stack of electrodes is then inserted in a container formed of stainless steel or aluminum, for example.

The separator may be a porous insulating film of resin such as polyethylene (PE) or polypropylene (PP), a stack of such films, or a dispersion of an inorganic compound such as alumina, for example.

The container is then filled with a nonaqueous electrolyte consisting of lithium salt, which electrochemically binds the cathode and the anode, dissolved in a nonaqueous solvent, which is poured in a working container in a dry air or inert gas atmosphere. The container is then sealed, thereby preparing a device.

Lithium salt supplies lithium ion that is transported in the electrolyte as the battery is charged and discharged. It may be LiClO₄, LiCF₃SO₃, LiPF₆, LiBF₄, LiAsF₆, or the like, or a combination of two or more thereof.

The organic solvent may consist primarily of a straight-chain or cyclic carbonate, in which an ester or an ether may be optionally mixed.

Examples of the carbonate include ethylene carbonate (EC), propylene carbonate, butylene carbonate, dimethyl carbonate (DMC), diethyl carbonate (DEC), methyl-ethyl carbonate, diethyl carbonate, and methyl acetate. A nonaqueous solvent consisting of one or a mixture of these carbonates is used.

In order to prevent a side reaction or to enhance the stability of the battery at high temperature, various additives may be added as needed. Examples of the additive used include an organic compound having a double bond such as vinylene carbonate, a sulfric compound, and a phosphorous compound, some of which may dissolve in the aforementioned solvent or double as a solvent.

When a rectangular electric energy storage device is to be prepared, the following process is preferably employed.

The application of the cathode and anode is the same as in the case of preparing the cylindrical electric energy storage device.

In order to prepare a rectangular electric energy storage device, a group of windings about a rectangular center pin is prepared and housed in a rectangular container, as in the cylindrical electric energy storage device. The container is then filled with an electrolyte and sealed.

Instead of the group of windings, a stacked body prepared by stacking a separator, cathode, separator, anode, and separator in the mentioned order may be used.

As an embodiment of the use of such electric energy storage device, a plurality of the electric energy storage devices may be electrically connected to form an electric energy storage module.

An electric energy storage module can be obtained by connecting a plurality of electric energy storage devices in series and/or in parallel.

The electric energy storage device has high output and superior high-load resistance properties, so that it can provide a high-output and long-life electric energy storage module.

Such electric energy storage device may be used as at least part of a power source for transport equipment, such as a device having a power unit, such as a motor, and a driven unit driven by the power unit.

Such, electric energy storage device may be used as at least part of a power source in a device having an internal combustion engine or fuel cells, in which the internal combustion engine or the fuel cells is used as another part of the power source separately from the electric energy storage device.

Such internal combustion engine or fuel cells are used as an energy source for charging the electric energy storage device. Such mode of use may be adopted in a hybrid electric vehicle.

Such hybrid electric vehicle that utilizes as a power supply the high-output electric energy storage device having high-output and superior high-load resistance properties has superior acceleration and excellent mileage.

Other examples of relevant transport equipment include an electric vehicle that has a motor as a power unit and wheels as a driven unit, light vehicles such as bicycles, and engines equipped with a generator driven by an internal combustion engine or the like.

Application of the electric energy storage device are not limited to the aforementioned transport equipment and include power supplies for a variety of portable equipment, information equipment, and power tools, for example. Other applications include power sources for industrial equipment such as elevators and power supplies for various business or household electric energy storage systems.

In accordance with the present embodiment, improvements in capacity and output performance can be achieved.

The electric energy storage device according to the present embodiment can be realized by an electric energy storage device in which the factor of an electric double layer capacitor, which has a mainly non-faradic reaction mechanism, is incorporated in the cathode of a lithium ion battery, which has a mainly faradic reaction mechanism (through the formation of separate regions). For example, an electric energy storage device according to the embodiment can be realized by an electric energy storage device in which a cathode is formed by separate regions for the cathode active material having a faradic reaction and activated carbon used as the material for the electric double layer capacitor, and in which a carbon material according to the present embodiment is used in the anode of the lithium ion battery.

Because the electric energy storage device incorporates the factor of the electric double layer capacitor in the cathode of the lithium ion battery, which is faradic, and employs the carbon material according to the present embodiment in the anode, good characteristics can be provided even when a high input/output load that exceeds the load of the lithium ion battery is applied to the anode during use.

Performance of the device does not drop even if high input/output load is repeated and sufficient high-input/output load resistance can be obtained. Thus, the problem of how to extend the life of the electric energy storage device can be solved.

In the following, detailed examples of the electric energy storage device according to the present embodiment will be described, to which the invention obviously is not limited.

### EXAMPLE 1

Coin-shaped electric energy storage devices (device A, device B, device C, and device D) were prepared as described below.

A cathode was prepared.

As the cathode active material, a powder of compound oxide having a composition formula of LiNi_{0.35}Mn_{0.35}Co_{0.3}O₂ was used.

To 85 wt. % of this cathode active material was added 9 wt. % of squamous graphite and 1.7 wt. % of acetylene black as conductant agent and a solution that consisted of NMP in which 4.3 wt. % of PVDF as a binder had been dissolved in advance, thereby preparing a cathode mix slurry.

Then, 90 wt. % of activated carbon with a specific surface area of 1500 m²/g was mixed with a solution consisting of NMP in which and 10 wt. % of PVDF had been dissolved, thereby preparing an activated carbon slurry.

The cathode mix slurry was applied to an aluminum foil (cathode collector) with a thickness of 20 μm substantially uniformly and evenly and then dried. Further, the activated carbon slurry was applied and dried, thereby providing a cathode collector, a region having a faradic reaction mechanism, and a region having a non-faradic reaction mechanism.

The individual amounts applied were adjusted such that the ratio of activated carbon was 5 wt. % with respect to 95 wt. % of the cathode active material.

Thereafter, a diameter of 15 mm was punched out and then compress-formed with a press machine, thereby preparing a cathode. The thickness of the thus obtained cathode was measured with a micrometer.

Next, an anode was prepared.

As the anode active material, carbon material I, carbon material II, carbon material III, and carbon material IV were selected that had physical properties shown in Table 1 below.

TABLE 1

| Carbon | d(002) | | True density | True density |
|---|---|---|---|---|
| material | (nm) | Lc (nm) | (helium) (g/cm³) | (butanol) (g/cm³) |
| Carbon HI | 0.391 | 1.5 | 1.52 | 1.37 |
| Carbon I | 0.380 | 1.6 | 1.57 | 1.49 |
| Carbon II | 0.365 | 4 | 1.77 | 1.69 |
| Carbon III | 0.346 | 16 | 2.02 | 1.86 |
| Carbon IV | 0.343 | 98 | 2.10 | 1.92 |
| Carbon HII | 0.337 | 200 | 2.12 | 2.01 |

Using these carbon materials I to IV as anode active material, 90 wt. % of the anode active material was mixed with 5 wt. % of acetylene black as conductant agent and a solution consisting of NMP in which and 5 wt. % of PVDF as a binder had been dissolved in advance, thereby preparing an anode mix slurry.

The anode mix slurry was then uniformly and evenly applied to a rolled copper foil (anode collector) with a thickness of 15 μm in the same procedure as in the case of the cathode, and then dried at 80° C.

The amounts applied were adjusted such that the weight of the anode mix after drying became constant in each device.

Thereafter, a diameter of 16 mm was punched out and then subjected to compression molding with a press machine, thereby preparing an anode. Uniform press pressure was employed for each device.

The thickness of the thus obtained anode was measured with a micrometer, and the anode mix density was calculated based on the area of the anode and the weight of the anode mix.

A separately punched anode was subjected to X-ray diffraction measurement using a CuKα ray in the range of 2θ of 20° to 60°.

Table 2 shows the carbon materials used in the anode, densities of the mix, presence or absence of diffraction lines other than (001), output, and capacity of the devices A to D prepared in Example 1.

TABLE 2

| | | Carbon | Mix | Diffraction | | |
|---|---|---|---|---|---|---|
| | | material (anode | density | line other | Output | Capacity |
| | Device | active material) | (g/cm³) | than (001) | (W/cm³) | (mAh/cm³) |
| Ex. 1 | Device A | Carbon I | 1.00 | None | 10.0 | 51 |
| | Device B | Carbon II | 1.30 | None | 11.6 | 59 |
| | Device C | Carbon III | 1.35 | None | 11.3 | 58 |
| | Device D | Carbon IV | 1.38 | None | 10.1 | 56 |
| Comp. | Device HA | Carbon HI | 0.81 | None | 8.0 | 37 |
| Ex. 1 | Device HB | Carbon HII | 1.40 | Present | 12.4 | 72 |
| Comp. | Device HC | Carbon II | 1.30 | None | 9.9 | 65 |
| Ex. 2 | | | | | | |

FIG. 2 shows the X-ray diffraction line pattern of the anode of Device A. As shown in FIG. 2, no diffraction line other than the (002) plane was observed from the anode of Device A. Substantially no diffraction line other than the (002) plane was observed from the anode of Devices B, C, and D.

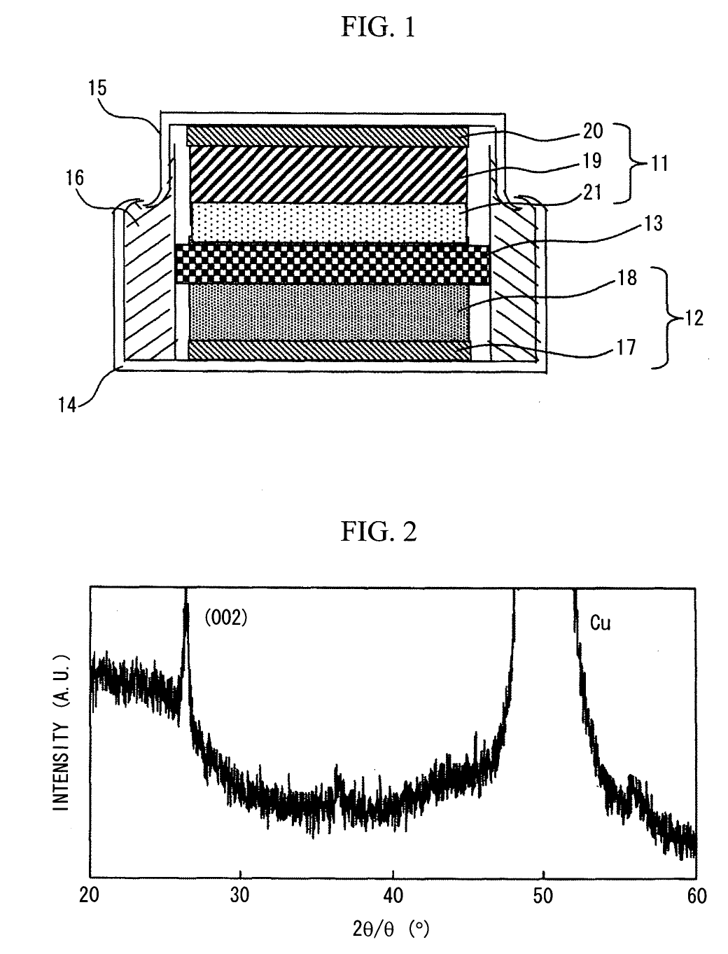

Using the prepared cathode and anode, a coin-shaped electric energy storage device shown in FIG. 1 was prepared.

Using a cathode 11 and an anode 12, a stack of electrodes was prepared by placing a fine porous polypropylene separator 13 with a thickness of 25 μm between them.

The volume of the stack of electrodes was calculated based on the areas of the cathode and anode, and the thicknesses of the cathode, anode, and separator. This stack of electrodes was inserted in a battery can 14 of stainless steel that doubles as an anode terminal. After the battery can 14 was filled with an electrolyte, a sealing cap portion 15 on which a cathode terminal was mounted was attached to the battery can 14 by crimping in an airtight manner via a packing 16, thereby preparing a coin-shaped electric energy storage device.

The nonaqueous electrolyte used consisted of a mixture solvent of EC, DMC, and DEC with a volume ratio of 1:1:1 in which 1 mol/L of LiPF₆ had been dissolved.

Referring to FIG. 1, the anode 12 includes an anode collector 17 and an anode mix layer 18. The cathode 11 includes a region 19 having a faradic reaction mechanism, a cathode collector 20, and a region 21 having a non-faradic reaction mechanism.

In this case, in the cathode 11, the region 19 having the faradic reaction mechanism is formed on the cathode collector 20, and the region 21 having the non-faradic reaction mechanism is formed on the region 19 having the faradic reaction mechanism. Alternatively, the region 19 having the faradic reaction mechanism and the region 21 having the non-faradic reaction mechanism may each face the anode 12.

### COMPARATIVE EXAMPLE 1

As Comparative Example 1, coin-shaped electric energy storage devices (deices HA and HB) were prepared in the following manner.

The coin-shaped electric energy storage devices were prepared in the same manner as in Example 1 except that carbon materials HI and HII having the physical properties shown in Table 1 were selected as the anode active material.

The prepared anode was subjected to X-ray diffraction measurement as in Example 1.

Table 2 shows the carbon materials used in the anode, densities of the mix, presence or absence of diffraction lines other than (001), output, and capacity of the devices HA and HB prepared in Comparative Example 1.

When the X-ray diffraction line pattern of the anode of Device HB is observed, it was seen that the (101 ) plane was slightly observable from the anode of Device HB in the vicinity of 2θ of 45°.

### COMPARATIVE EXAMPLE 2

As Comparative Example 2, a coin-shaped electric energy storage device (device HC) was prepared as follows.

The device HC (lithium ion battery) is similar to device B according to Example 1 except that, during the preparation of the cathode, no region having the non-faradic reaction mechanism was provided.

Table 2 shows the carbon material used in the anode, mix density, presence or absence of diffraction lines other than (001), output, and capacity of device HC prepared in Comparative Example 1.

(Measurement of Capacity)

The capacity of the coin-shaped electric energy storage devices according to Example 1 and Comparative Examples 1 and 2 was measured as follows.

The prepared electric energy storage devices were charged and discharged three times at 20° C., and the discharge capacity at the third time was determined to be the rated capacity of the batteries.

The charge/discharge conditions included constant-current/constant-voltage charging with 1 mA at an upper-limit voltage of 4.1 V for 2.5 hours, and constant-current discharging with 1 mA at a lower-limit voltage of 2.7 V.

The discharge capacity at the third time was divided by the volume of the stack of electrodes and the resultant value was determined to be the capacity of the electric energy storage device.

(Measurement of Output)

The output of the coin-shaped electric energy storage devices according to Example 1 and Comparative Examples 1 and 2 was measured as follows.

After the measurement of capacity, the devices were charged with constant-current/constant-voltage with 1 mA and an upper-limit voltage of 3.9 V for 2 hours and then outputs were measured.

The devices were discharged with a discharge current of 2 mA for 10 seconds, and then an open-circuit voltage (V₀) prior to discharge and a voltage (V₁₀) 10 seconds after discharge were measured. The difference between them (V₀-V₁₀), which is a voltage drop (ΔV), was determined.

Thereafter, the devices were charged up to a quantity corresponding to the discharged quantity of electricity. Voltage drops (ΔV) were similarly determined while the discharge current was sequentially changed from 10 mA and 20 mA.

Through the extrapolation of the voltage drops (ΔV) with respect to the discharge current values, a maximum current value (I_{MAX}) was determined assuming that a final discharge voltage of 2.5 V would be reached in 10 seconds. I_{MAX} was multiplied by 2.5 V to obtain a value which was then divided by the volume of the stack of electrodes, thereby determining the output of the electric energy storage device.

The result of the measurement of the output and capacity of the coin-shaped electric energy storage devices according to Example 1 and Comparative Examples 1 and 2 is also shown in Table 2.

As compared with device HA of Comparative Example 1 and device HC of Comparative Example 2, the coin-shaped electric energy storage devices of Example 1 produced higher outputs. Namely, the coin-shaped electric energy storage devices of Example 1 produced outputs of 10.0 W/cm³ or higher.

With regard to the coin-shaped electric energy storage devices of Example 1, devices B, C, and D provided higher capacities (56 mAh/cm³or more) than device A.

Furthermore, with regard to the coin-shaped electric energy storage devices of Example 1, devices B and C provided higher outputs (11.3 W/cm³ or more) than devices A and D.

(Evaluation of High-Input/Output Load Resistance)

The high-input/output load resistance of the coin-shaped electric energy storage devices according to Example I and Comparative Examples 1 and 2 were evaluated as follows.

As in the measurement of output, voltage drops (ΔV) 10 seconds after discharge with discharge currents of 2 mA, 10 mA, and 20 mA were measured.

The voltage drops (ΔV) were plotted against the discharge current values. The resistance of the devices was measured from the slope of the thus plotted I-ΔV plot.

The electric energy storage devices, after the measurement of resistance, were subjected to a high-load charge/discharge cycle. After charging up to 3.6 V, a cycle of discharge with 40 mA for 10 seconds and charge with 40 mA for 10 seconds was continually repeated, thereby conducting a cycle test.

Resistance was measured at intervals of 2000 cycles, and the rate of increase of resistance along the cycles was measured against the resistance value of 100 at zero cycle.

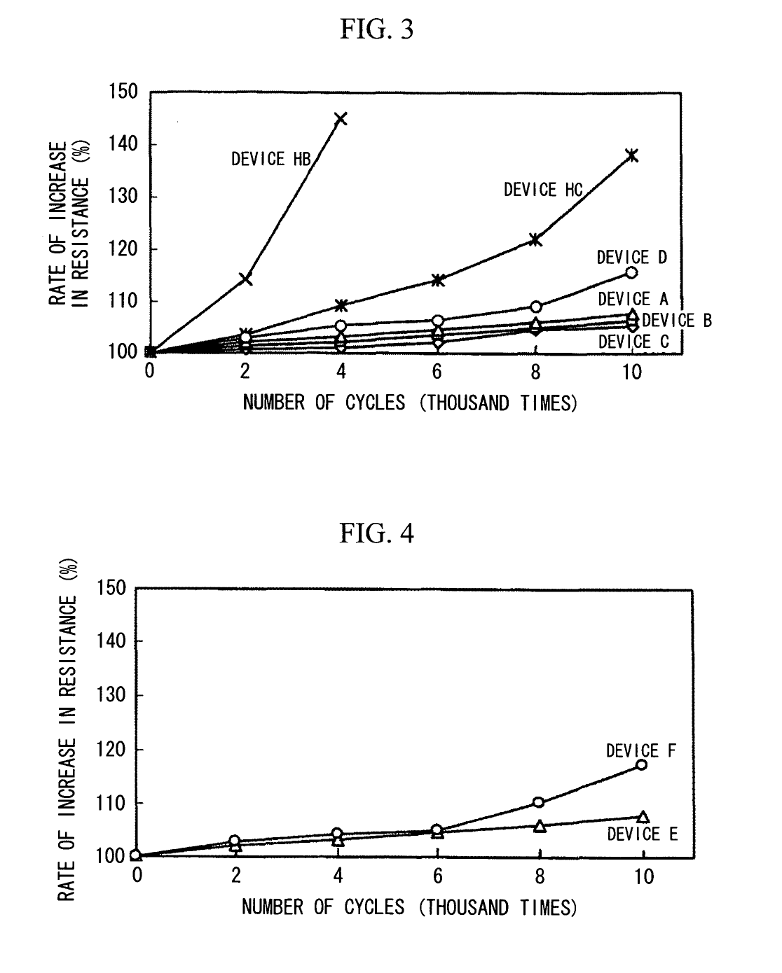

FIG. 3 shows the resistance increase rates of the electric energy storage devices (A to D) of Example 1, device HB of Comparative Example 1, and device HC of Comparative Example 2 with respect to the number of cycles.

As compared with device HB of Comparative Example 1 and device HC of Comparative Example 2, the electric energy storage device of Example 1 had a smaller resistance increase rate, thus exhibiting better high-input/output load resistance (cycle characteristics).

Further, it can be seen that, regarding the coin-shaped electric energy storage devices of Example 1, devices A, B, and C exhibit higher cycle characteristics than device D.

### EXAMPLE 2

Coin-shaped electric energy storage devices (devices E and F) were prepared as follows.

The coin-shaped electric energy storage devices were similar to device C of Example 1 except that during the preparation of the anode, the anode mix density was adjusted by controlling the press pressure.

Table 3 shows the result of measurement of the mix density of the anode, output, and capacity of the devices of Example 2 as well as device C of Example 1.

TABLE 3

| | | | | Diffrac- | | |
|---|---|---|---|---|---|---|
| | | Carbon | | tion | | |
| | | material | | lines | | |
| | | (anode | Mix | other | | Capacity |
| | | active | density | than | Output | (mAh/ |
| | Device | material) | (g/cm³) | (001) | (W/cm³) | cm³) |
| Ex. 1 | Device C | Carbon III | 1.35 | None | 11.3 | 58 |
| Ex. 2 | Device E | Carbon III | 1.00 | None | 11.0 | 54 |
| | Device F | Carbon III | 1.45 | None | 10.2 | 60 |

FIG. 4 shows the resistance increase rate with respect to the number of cycles in each device of Example 2.

With regard to the coin-shaped electric energy storage devices of Example 2, it can be seen that device E exhibits higher cycle characteristics than device F.

In the coin-shaped electric energy storage device using carbon III, the mix density of the anode could be increased. Thus, a more preferable high-capacity electric energy storage device was obtained by increasing the mix density of the anode to 1.30 g/cm³ or higher.

Further, as compared with device HB of Comparative Example 1 and device HC of Comparative Example 2, the resistance increase rate was smaller, thus indicating a higher high-input/output load resistance (cycle characteristics).

What is claimed is:

1. An electric energy storage device comprising:
a cathode including a region having a faradic reaction mechanism and a region having a non-faradic reaction mechanism; and
an anode including a region having a faradic reaction mechanism,
wherein, when a carbon material contained in said anode is represented by a diffraction line according to X-ray diffraction method, mainly the (001) plane is substantially detected.

2. The electric energy storage device according to claim 1, wherein said region having the faradic reaction mechanism and said region having the non-faradic reaction mechanism are formed in layers.

3. The electric energy storage device according to claim 1, wherein said region having the non-faradic reaction mechanism is distributed in said region having the faradic reaction mechanism.

4. An electric energy storage device comprising:
a cathode including a region having a faradic reaction mechanism and a region having a non-faradic reaction mechanism; and
an anode including a region having a faradic reaction mechanism,
wherein, when a carbon material contained in said anode is represented by a diffraction line according to X-ray diffraction method, the ratio of a peak intensity of the (002) plane to a peak intensity of the (hk0) plane (hk0)/(002) is 0.01 or less.

5. The electric energy storage device according to claim 1, wherein the faradic reaction mechanism comprises the intercalation/desorption reaction of lithium ion.

6. The electric energy storage device according to claim 1, wherein the non-faradic reaction mechanism comprises the absorption/desorption reaction of anion.

7. The electric energy storage device according to claim 1, wherein the carbon material contained in said anode is an anode active material that causes an intercalation/desorption reaction of lithium ion.

8. The electric energy storage device according to claim 7, wherein said anode active material is such that:
(1) the interlayer spacing (d value) of the (002) plane according to X-ray diffraction method is 0.343 to 0.390 nm; and
(2) the crystallite thickness (Lc) in the C-axis direction of the (002) plane according to X-ray diffraction method is 1.6 nm to 100 nm.

9. The electric energy storage device according to claim 1, wherein the density of the anode mix of said anode is 1.1 g/cm³ to 1.7 g/cm³.

10. The electric energy storage device according to claim 9, wherein the anode active material is such that:
(1) the true density according to helium absorption method is 1.6 g/cm³ to 2.1 g/cm³;
(2) the true density according to butanol method is 1.5 g/cm³ to 2.0 g/cm³;
(3) the interlayer spacing (d value) of the (002) plane according to X-ray diffraction method is 0.343 nm to 0.365 nm; and
(4) the crystallite thickness (Lc) in the C-axis direction of the (002) plane according to X-ray diffraction method is 3.0 nm to 100 nm.

11. An electric energy storage module comprising a plurality of the electric energy storage devices according to claim 1 electrically connected.

12. A transport device comprising the electric energy storage device according to claim 1 as at least a part of a power source thereof.

13. A hybrid electric vehicle comprising:
the electric energy storage device according to claim 1; and
an internal combustion engine or a fuel cell,
wherein said electric energy storage device is used as at least a part of a power source of said hybrid electric vehicle, and wherein said internal combustion engine or said fuel cell is used as another part of said power source and as an energy source for charging said electric energy storage device.

14. An electric energy storage device comprising:
a cathode including a region having a faradic reaction mechanism and a region having a non-faradic reaction mechanism; and
an anode including a region having a faradic reaction mechanism,
wherein said anode comprises an anode active material that causes an intercalation/desorption reaction of lithium ion,
wherein said anode active material is such that:
(1) the interlayer spacing (d value) of the (002) plane according to X-ray diffraction method is 0.343 to 0.365 nm; and
(2) the crystallite thickness (Lc) in the C-axis direction of the (002) plane according to X-ray diffraction method is 3.0 nm to 100 nm.

15. The electric energy storage device according to claim 14, wherein said region having the non-faradic reaction mechanism comprises activated carbon.

16. An electric energy storage device comprising:
a cathode including a first region for the charge/discharge of lithium ion, and a second region for the charge/discharge of lithium ion at a rate faster than the charge/discharge of lithium ion in said first region; and
an anode such that:
(1) the interlayer spacing (d value) of the (002) plane according to X-ray diffraction method is 0.343 to 0.365 nm; and
(2) the crystallite thickness (Lc) in the C-axis direction of the (002) plane according to X-ray diffraction method is 3.0 nm to 100 nm.
